(19) United States
(12) Patent Application Publication
(10) Pub. No.: US 2008/0072924 A1
(43) Pub. Date: Mar. 27, 2008

(54) Fouling removing method

(75) Inventors: Kazuo Nakamae, Yokohama-shi (JP); Motoki Kakui, Yokohama-shi (JP); Shinobu Tamaoki, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/882,168

(22) Filed: Jul. 31, 2007

(30) Foreign Application Priority Data
Sep. 25, 2006 (JP) P2006-259224

(51) Int. Cl. B08B 6/00

(52) U.S. Cl. 134/1

(57) ABSTRACT

The present invention relates to a fouling removing method which removes a fouling, comprised of a chemical compound containing carbon, on an object surface by laser light irradiation. The fouling removing method irradiates the fouling on the object surface with laser light while blowing a supporting gas on this area. This structure allows the supporting gas and a fouling material to react with each other when burning the fouling by laser irradiation, so as to generate a carbon-containing gas, and the supporting gas to blow away carbonized residues generated on the object surface. This drastically reduces the carbonized residues on the exposed surface of the object having removed the fouling.

### BACKGROUND OF THE INVENTION

1. Field of the Invention

The present invention relates to a fouling removing method which partly removes, in a coating comprised of a chemical compound containing carbon which covers a surface of an object (hereinafter referred to as “carbon-containing coating”), a corresponding area of the carbon-containing coating positioned on a region to be exposed of the object by laser light irradiation.

2. Related Background Art

As a method removing a part of a carbon-containing coating covering at least a part of a surface of an object to be processed, techniques utilizing laser light have been known. Partial coating removal by laser light irradiation is effective in particular when a branch lead is connected by soldering or the like to a lead whose surface is coated with a carbon-containing coating. Such a coating removing method by laser light irradiation is described, for example, in Miyazaki, Toshiyuki, “Laser Processing Technique”, Sangyo Tosho Publishing Co., Ltd., 1st edition, 6th printing, Aug. 8, 2003.

### SUMMARY OF THE INVENTION

The present inventors have examined the above prior art, and as a result, have discovered the following problems. Namely, when carbon is contained in a part of the coating to be removed (a region selected as an area to be removed), the conventional coating removing method by laser light irradiation has been highly likely to leave carbonized residues on the surface of the object to be processed after the laser light irradiation. When a branch lead is connected by welding, soldering, or the like to a lead whose surface is covered with a carbon-containing coating, such carbonized residues may cause a contact failure (conduction failure) between the lead that is an object to be processed and the branch lead.

The present invention has been developed to eliminate the problems described above. It is an object of the present invention to provide a fouling removing method which can drastically reduce carbonized residues on the exposed object surface even when partly removing a selected area of the carbon-containing coating covering the object surface by laser light irradiation.

A fouling removing method according to the present invention removes a fouling comprised of a chemical compound containing carbon which is attached to an object surface. Here, the present invention mainly assumes, as a fouling, a carbon-containing coating (coating comprised of a chemical compound containing carbon) which covers an object surface, and partly removes a selected area in the carbon-containing coating which covers the object surface. In particular, this fouling removing method comprises a step of preparing an object to be irradiated with laser and a laser light irradiation step.

The object to be irradiated with laser has a surface covered with the carbon-containing coating. In the laser light irradiation step, the corresponding area of the carbon-containing coating (selected area of the carbon-containing coating), positioned on a region to be exposed of the object surface covered with the carbon-containing coating, is irradiated with laser light while being blown with a supporting gas. This structure allows the supporting gas and a coating material to react with each other when burning the coating by laser irradiation, so as to generate a carbon-containing gas, and the supporting gas to blow away the carbonized residues generated on the object surface. This drastically reduces the carbonized residues on the object surface exposed by the laser light irradiation.

In the fouling removing method according to the present invention, it is preferable that the supporting gas is supplied through a tube from a container pressurized to a pressure higher than that of an atmosphere surrounding the object. In this case, the carbonized residues existing on the exposed surface of the object are physically removed by the supporting gas blown thereon.

In the fouling removing method according to the present invention, the supporting gas preferably contains an oxygen gas. This generates a carbon dioxide gas when burning the coating by laser light irradiation, thereby drastically reducing the carbonized residues.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a view for conceptually explaining a fouling removing method according to the present invention; and

FIG. 2 is a view for specifically explaining an embodiment of the fouling removing method according to the present invention.

### DETAILED DESCRIPTION OF THE PREFERRED EMBODIMENTS

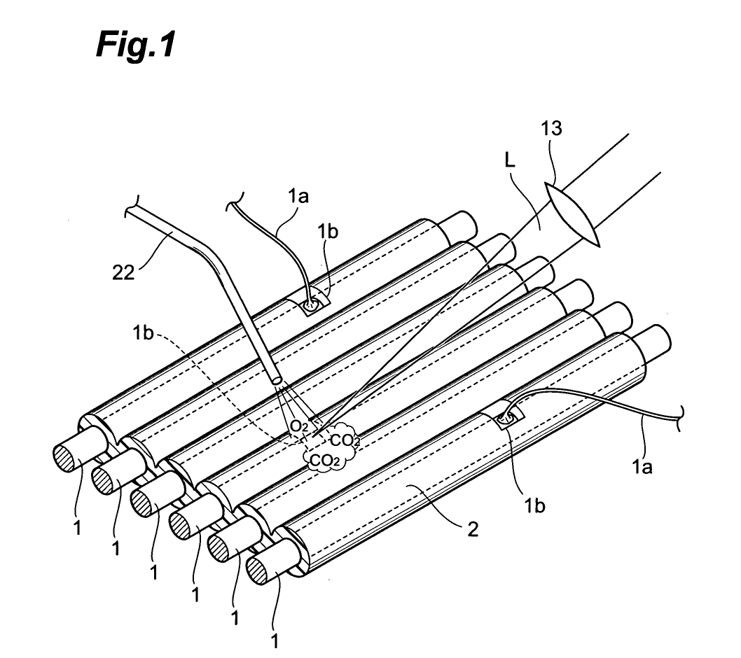

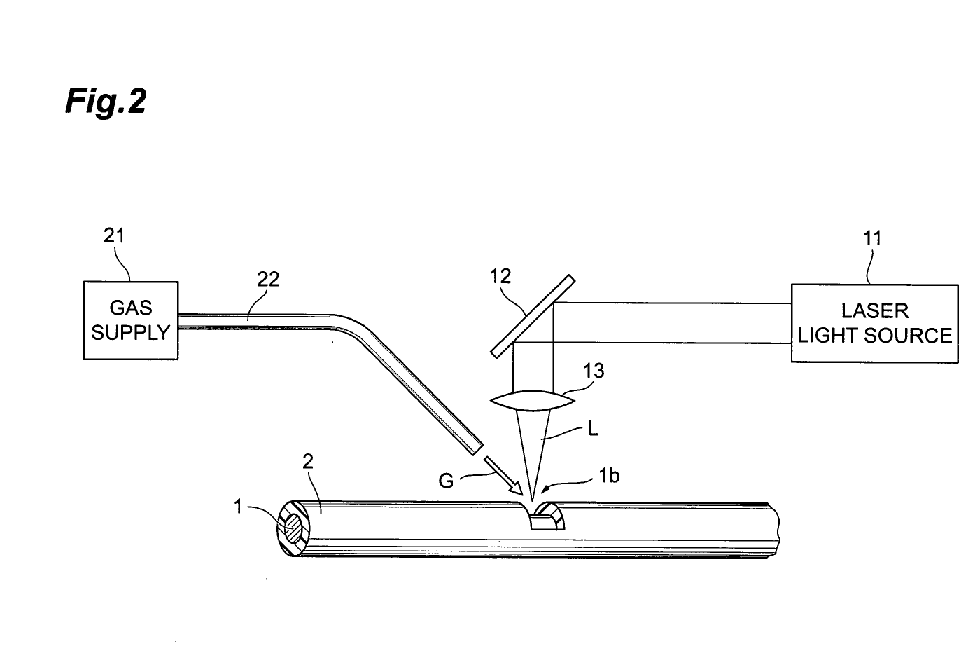

In the following, embodiments of a fouling removing method according to the present invention will be explained in detail with reference to FIGS. 1 and 2. In the explanation of the drawings, the same constituents will be referred to with the same numerals while omitting their overlapping descriptions.

FIG. 1 is a view for conceptually explaining the fouling removing method according to the present invention. As shown in FIG. 1, the fouling removing method according to the present invention is effective in particular when connecting branch leads 1a to a plurality of leads 1 covered with a carbon-containing coating 2. Typically, when connecting the branch lead 1a to one of the leads 1 covered with the carbon-containing coating 2, a corresponding area of the coating 2 positioned on a region to be exposed (the region in contact with the branch lead 1a) in the lead 1 to be connected is burned by selective irradiation with laser light L. As a result of burning the coating by the laser light irradiation, a depression 1b exposing a part of the surface in the lead 1 is obtained. Then, the exposed part of the lead 1 and one end of the branch lead 1a are soldered to each other, whereby an operation of connecting the lead 1 and branch lead 1a to each other is completed. However, simple irradiation with the laser light L alone may leave carbonized residues in the exposed area of the lead 1, whereby the lead 1 and branch lead 1a may fail to establish sufficient conduction therebetween. Therefore, the fouling removing method according to the present invention irradiates a part of the carbon-containing coating 2 to be removed with the laser light L while blowing this part with a supporting gas G such as O₂ gas, for example, supplied through a tube 22. Here, the O₂ gas and a coating material react with each other, so as to yield a carbon-containing gas such as CO gas or CO₂ gas, while the carbonized residues generated on the surface of the lead 1 are blown away by the O₂ gas. As a result, the carbonized residues on the surface of the lead 1 exposed by the laser light irradiation drastically decrease, whereby a sufficient connection strength is obtained between the lead 1 and branch lead 1a.

An embodiment of the fouling removing method according to the present invention will now be explained more specifically. FIG. 2 is a view for specifically explaining one embodiment of the fouling removing method according to the present invention.

In this embodiment, the object to be processed 1 is a lead. The carbon-containing coating 2 to be removed is a resin coating covering at least a part of the outer peripheral face of the lead 1 and containing a heat-resistant material. The heat-resistant material contains carbon. As shown in FIG. 2, a coating removing apparatus employed in the fouling removing method according to this embodiment comprises a laser light source 11, a mirror 12, a lens 13, a gas supply 21, and a gas tube 22.

The laser light L outputted from the laser light source 11 is reflected by the mirror 12 and then is converged on the surface of the carbon-containing coating 2 through the lens 13. On the other hand, the supporting gas G supplied from the gas supply 21 is blown against a laser light irradiation area in the carbon-containing coating 2 through the gas tube 22. Namely, for drastically reducing the carbon residues remaining in the exposed surface (area defined by the depression 1b) of the lead 1, the fouling removing method according to this embodiment irradiates the selected area of the carbon-containing coating 2 with the laser light L and introduces the supporting gas G to this irradiation area.

Since the irradiation with laser light and the supply of supporting gas (blowing with the supporting gas) are performed simultaneously as mentioned above, the residual carbides drastically decrease on the exposed surface of the lead 1 (the region where the carbon-containing coating 2 is partly removed by laser light irradiation).

Here, it will be preferred that the supporting gas G is supplied through the gas tube 22 from a container (included in the gas supply 21) pressurized to a pressure higher than that of the atmosphere surrounding the lead 1 that is the object to be processed. In this case, the carbonized residues existing on the exposed surface of the lead 1 can efficiently be removed by the supporting gas G blown at a high pressure.

Preferably, the supporting gas G is an oxygen gas (O₂). In this case, a material of the carbon-containing coating 2 can react with the oxygen gas, thereby yielding a carbon-containing gas such as CO gas or CO₂ gas.

An experiment employing a Cu lead as the lead 1 that is the object to be processed, while a lead-coating resin containing a heat-resistant material, e.g., a fluorine resin such as PFA (tetrafluoroethylene perfluoroalkyl vinyl ether copolymer), as the carbon-containing coating 2 will now be explained specifically. PFA employed in this experiment had a thickness of 50 μm. The width by which the carbon-containing coating 2 was removed by laser light irradiation was 30 μm, whereby the resulting depression 1b had an aspect ratio (ratio of thickness to width) of 1.7.

A YAG laser light source was employed as the laser light source 11. The wavelength of the laser light L was 1064 nm, the average output power of the laser light L was 10 W, and the pulse width of the laser light L was 10 ns. The supporting gas G was an oxygen gas. A pressurized cylinder (200 kPa) was employed as the gas supply 21, whereby the pressurized supporting gas G was supplied to the laser light irradiation area of PFA. As a result, carbides to be generated on the exposed surface of the Cu lead 1 reacted with the oxygen gas, so as to yield a carbon-containing gas, whereby the surface was cleaned to such an extent that leads to be connected could establish conduction therebetween when they came into contact with each other.

As described above, even when partly exposing a surface of an object covered with a carbon-containing coating, the present invention can drastically reduce the residual carbides on the exposed surface of the object.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A fouling removing method of removing a fouling comprised of a chemical compound containing carbon which is attached to an object surface by laser light irradiation, said method comprising the steps of:
preparing an object having a surface attached with a fouling comprised of a chemical compound containing carbon; and
irradiating the fouling on the surface of the object with laser light while blowing a supporting gas thereon.

2. A fouling removing method according to claim 1, wherein the supporting gas is supplied through a tube from a container pressurized to a pressure higher than that of an atmosphere surrounding the object.

3. A fouling removing method according to claim 1, wherein the supporting gas contains an oxygen gas.
